(19) United States
(12) Patent Application Publication
(10) Pub. No.: US 2026/0040137 A1
(43) Pub. Date: Feb. 5, 2026

(54) SYSTEMS AND METHODS FOR PROVIDING A FEMTOCELL HYBRID ACCESS MODE TO USER EQUIPMENT

(71) Applicant: Verizon Patent and Licensing Inc., Basking Ridge, NJ (US)

(72) Inventors: Amir SAGHIR, Frisco, TX (US); Said HANBALY, Prosper, TX (US); Ali Imdad MALIK, East Brunswick, NJ (US)

(73) Assignee: Verizon Patent and Licensing Inc., Basking Ridge, NJ (US)

(21) Appl. No.: 18/793,075

(22) Filed: Aug. 2, 2024

(51) Int. Cl. H04W 28/02; H04W 48/06

(52) U.S. Cl. CPC H04W 28/0289; H04W 28/0284; H04W 48/06

(57) ABSTRACT

A femtocell may receive a closed access group (CAG) identifier (ID) for the femtocell and an indication of a hybrid mode of operation that causes the femtocell to provide an access network to a member user equipment (UE) and a non-member UE of the CAG. The femtocell may broadcast the CAG ID and the indication of the hybrid mode of operation to the member UE and the non-member UE, and may determine whether there is congestion associated with the access network provided by the femtocell. The femtocell may selectively provide, to the member UE and the non-member UE, access to the access network based on determining that there is no congestion associated with the access network provided by the femtocell, or provide, to only the member UE, access to the access network based on determining that there is congestion associated with the access network provided by the femtocell.

### BACKGROUND

The deployment of small, localized cellular base stations, such as femtocells, has become a widespread solution for extending cellular coverage (e.g., for a user equipment (UE)) and enhancing network capacity, especially in environments with poor signal coverage like buildings, homes, and remote areas.

### BRIEF DESCRIPTION OF THE DRAWINGS

FIGS. 1A-1F are diagrams of an example associated with providing a femtocell hybrid access mode to user equipments (UEs).

FIG. 2 is a diagram of an example environment in which systems and/or methods described herein may be implemented.

FIG. 3 is a diagram of example components of one or more devices of FIG. 2.

FIG. 4 is a flowchart of an example process for providing a femtocell hybrid access mode to UEs.

### DETAILED DESCRIPTION OF EXAMPLE EMBODIMENTS

The following detailed description of example implementations refers to the accompanying drawings. The same reference numbers in different drawings may identify the same or similar elements.

Femtocells often operate in one of two modes as dictated by the existing fifth-generation (5G) standards. A first mode is an open access mode, which allows any compatible device within range to connect and access services provided by a femtocell. A second mode is a closed access mode, where only devices listed and pre-approved can connect to and access services provided by the femtocell. Such configurations, while instrumental in managing femtocell resources and ensuring security, present a significant limitation in dynamic environments where priorities of devices (e.g., user equipments (UEs)) accessing the femtocell may vary, and femtocell resources must be optimally allocated. Thus, current techniques for providing UEs access to femtocells consume computing resources (e.g., processing resources, memory resources, communication resources, and/or the like), networking resources, and/or other resources associated with providing access to all UEs even when femtocell resources are limited, failing to provide access to non-approved UEs when femtocell resources are available, failing to determine when a femtocell is able to provide additional UEs (e.g., whether approved or non-approved) with access to the femtocell, and/or the like.

Some implementations described herein relate to a femtocell that provides a femtocell hybrid access mode to UEs. For example, the femtocell may receive a closed access group (CAG) identifier (ID) for the femtocell and an indication of a hybrid mode of operation that causes the femtocell to provide an access network to a member UE and a non-member UE of the CAG. The femtocell may broadcast the CAG ID and the indication of the hybrid mode of operation to the member UE and the non-member UE, and may determine whether there is congestion associated with the access network provided by the femtocell. The femtocell may selectively provide, to the member UE and the non-member UE, access to the access network based on determining that there is no congestion associated with the access network provided by the femtocell, or provide, to only the member UE, access to the access network based on determining that there is congestion associated with the access network provided by the femtocell.

In this way, a femtocell provides a femtocell hybrid access mode to UEs. For example, the femtocell may enable dynamic expansion and contraction of femtocell resource availability in response to real-time access network conditions and UE access classification. The femtocell may optimize traffic handling by dynamically shifting between the open access mode and the closed access mode. Additionally, the femtocell provides seamless integration with broader network infrastructure, achieving enhanced network management efficiency and technical coherence across an entire network system. Thus, the femtocell may conserve computing resources, networking resources, and/or other resources that would have otherwise been consumed by providing access to all UEs even when femtocell resources are limited, failing to provide access to non-approved UEs when femtocell resources are available, failing to determine when a femtocell is able to provide additional UEs (e.g., whether approved or non-approved) with access to the femtocell.

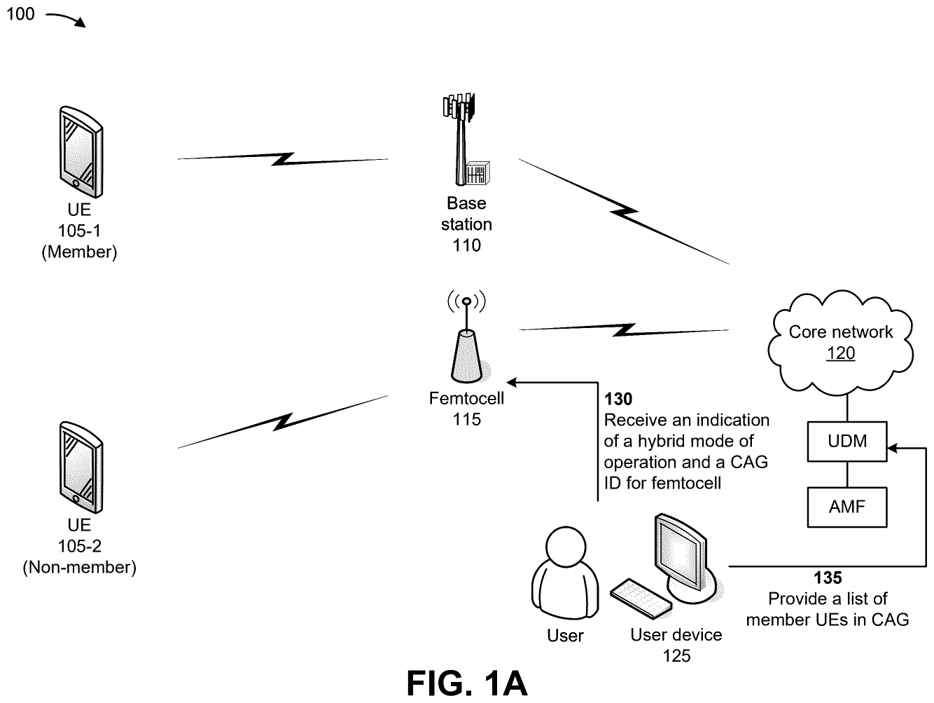

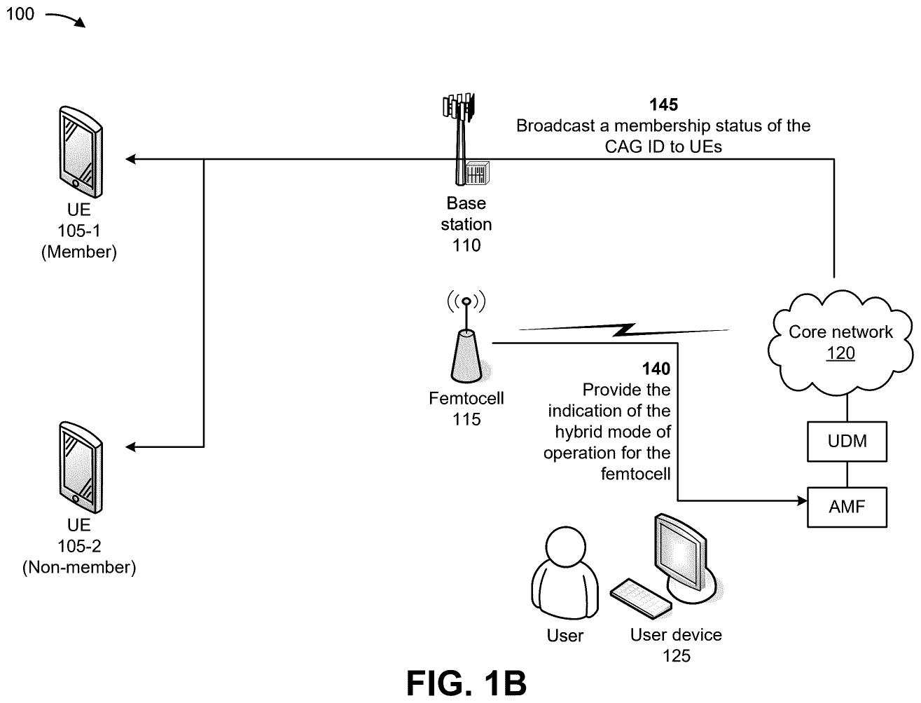

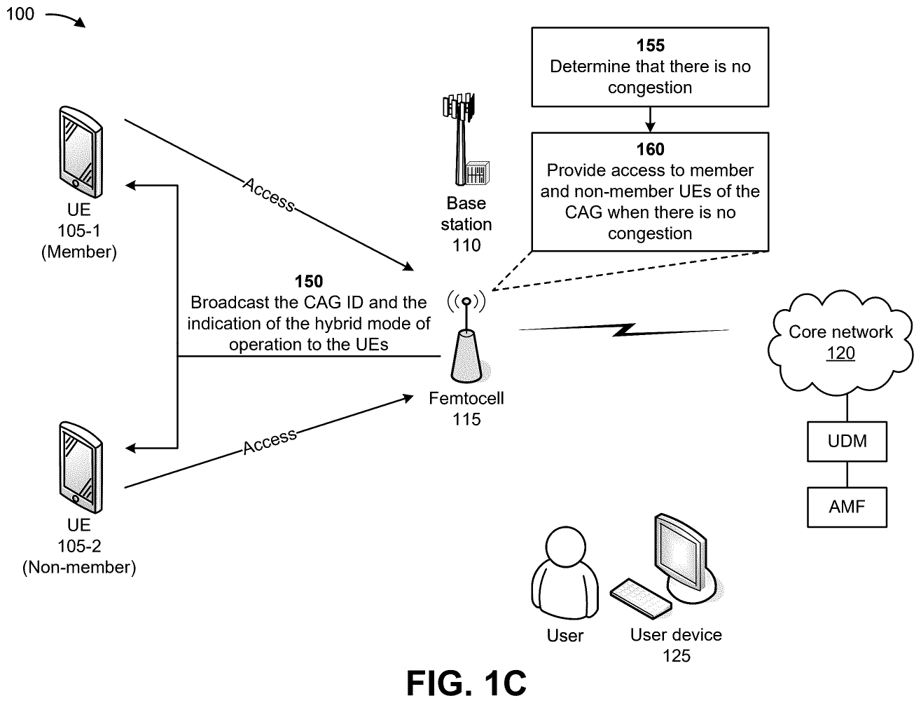

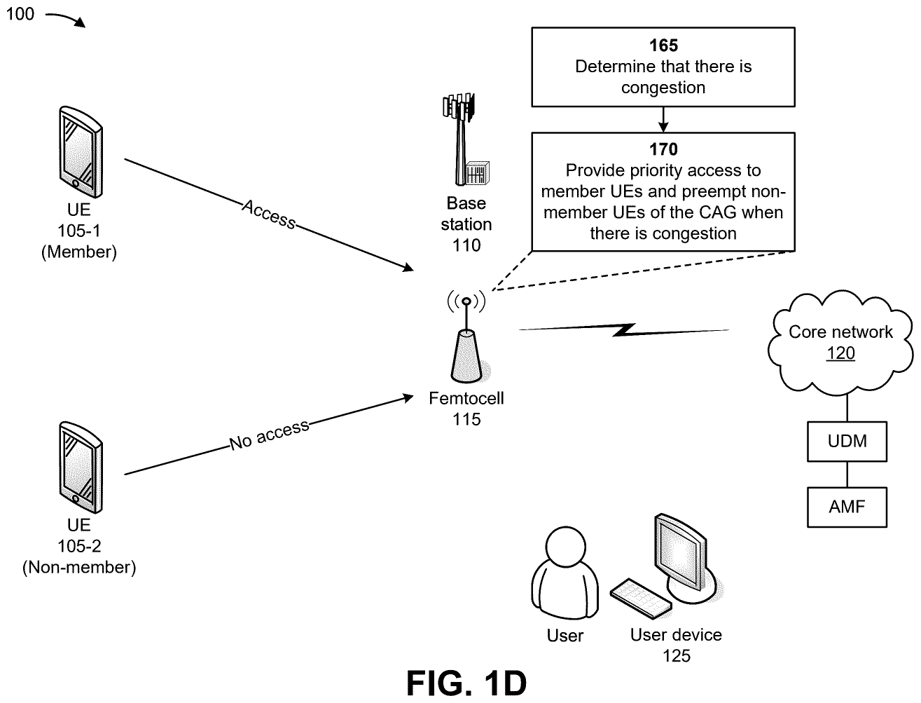

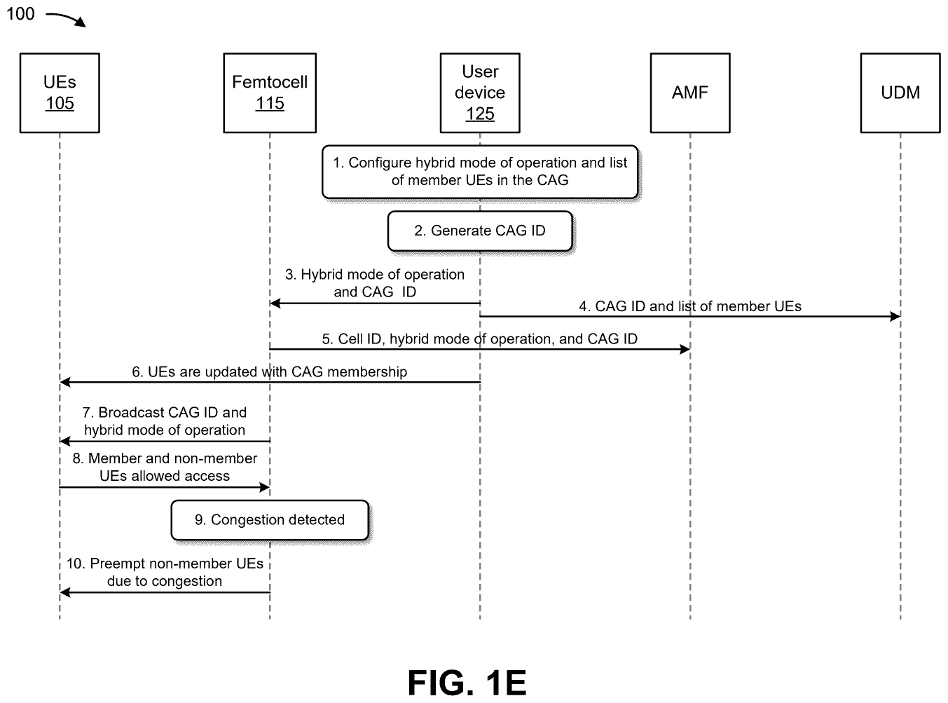

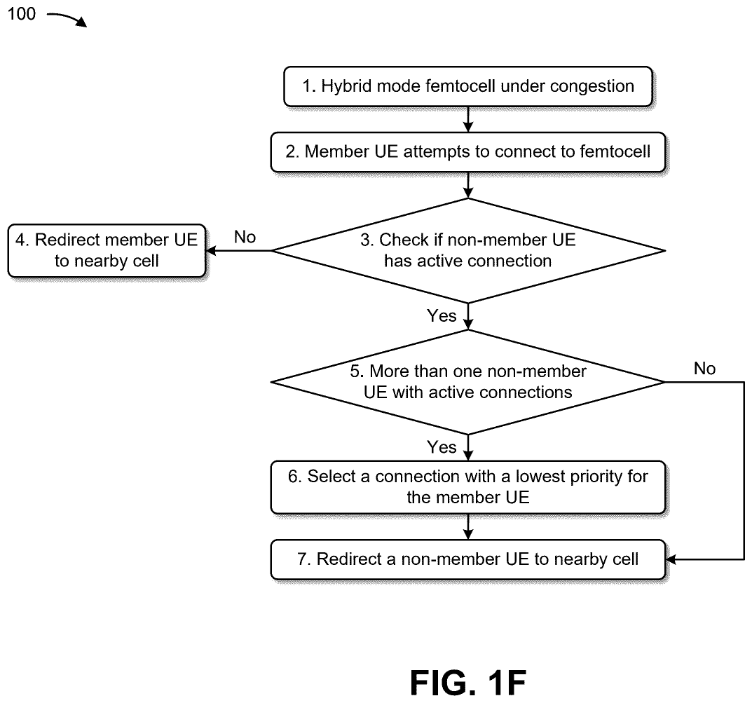

FIGS. 1A-1F are diagrams of an example 100 associated with providing a femtocell hybrid access mode to UEs. As shown in FIGS. 1A-1F, example 100 includes a first UE 105-1, a second UE 105-2, a base station 110, a femtocell 115, a core network 120, and a user device 125 associated with a user. The first UE 105-1 may be a member UE 105 of an access network provided by the femtocell 115, and the second UE 105-2 may be a non-member UE 105 of the access network provided by the femtocell 115. Further details of the UEs 105, the base station 110, the femtocell 115, the core network 120, and the user device 125 are provided elsewhere herein.

As shown in FIG. 1A, and by reference number 130, the femtocell 115 may receive an indication of a hybrid mode of operation and a CAG ID for the femtocell 115. For example, the user (e.g., an owner or an operator of the femtocell 115) may utilize the user device 125 to access a portal for configuring the femtocell 115. The user may utilize the user device 125 to generate the indication of the hybrid mode of operation (e.g., a hybrid access mode) and the CAG ID identifier for the femtocell 115. The user device 125 may provide the indication of a hybrid mode of operation and the CAG ID to the femtocell 115 via the portal, and the femtocell 115 may receive the indication of a hybrid mode of operation and the CAG ID. In some implementations, the hybrid mode of operation may be indicated by a binary value representative of an active operational status (e.g., a one) or an inactive operational status (e.g., a zero). Alternatively, or additionally, the femtocell 115 may automatically implement the hybrid mode of operation based on one or more conditions (e.g., load on the femtocell 115).

In some implementations, the femtocell 115 may receive alternative operational mode indications, such as an indication of an exclusively open access mode, an indication of an exclusively closed access mode, and/or the like. This capability allows for flexible adaptation to varying network requirements and preferences, where the femtocell 115 may transition between modes in response to different conditions or policies. Additionally, or alternatively, the femtocell 115 may receive configuration settings via an application or a network management system operated by a network provider or an owner of the femtocell 115, offering a diverse range of mediums for configuration management beyond a web-based interface. The configuration via an application, for instance, may provide a more secure and interactive way for an operator or an owner to configure the femtocell 115. Additionally, or alternatively, a configuration that includes the hybrid mode indication and the CAG ID, may be automatically received, by the femtocell 115, from a predefined network policy, or may be dynamically received, by the femtocell 115, in response to real-time network analysis, thereby enabling an autonomous and intelligent system capable of self-configuration based on network needs.

As further shown in FIG. 1A, and by reference number 135, the user device 125 may provide list of member UEs 105 in the CAG (e.g., provided by the femtocell 115) to a network device of the core network 120 (e.g., a unified data management (UDM) component). For example, the user (e.g., an owner or an operator of the femtocell 115) may utilize the user device 125 to access a portal for configuring network devices of the core network 120. The user may utilize the user device 125 to generate the list of member UEs 105 in the CAG. In some implementations, the list of member UEs 105 may identify the member UEs 105 based on mobile directory numbers (MDNs) or other identifiers associated with the member UEs 105. The user device 125 may provide the list of member UEs 105 in the CAG to the UDM of the core network 120 via the portal, and the UDM may receive the list of member UEs 105 in the CAG.

In some implementations, the user device 125 may provide the list of member UEs 105 to alternative network devices within the core network 120, such as a home subscriber server (HSS) in fourth-generation (4G) technology or functional equivalents of the HSS or the UDM in different network generations. Additionally, or alternatively, the core network 120 may include functionality to validate the membership status of the UEs 105 based on the provided list, such as cross-referencing with a subscription database, ensuring that only UEs 105 with valid subscriptions receive the benefits of the closed access group. Additionally, or alternatively, the list of member UEs 105 provided by the user device 125 may be augmented with priority levels for each member UE 105, dictating an order of preferential treatment during network congestion. This may provide for a more granular control over network resource allocation, taking into account not only the membership status, but also a criticality or an importance of data requirements of each member UE 105.

As shown in FIG. 1B, and by reference number 140, the femtocell 115 may provide the indication of the hybrid mode of operation (e.g., for the femtocell 115) to a network device of the core network 120 (e.g., an access and mobility management function (AMF)). For example, the femtocell 115 may inform the AMF of an operational mode (e.g., the hybrid mode) of the femtocell 115 for access control of the UEs 105. In some implementations, the femtocell 115 may provide a cell ID of the femtocell 115, the CAG ID, and the indication of the hybrid mode of operation to the AMF of the core network 120.

In some implementations, the indication of the hybrid mode of operation may include an indication of whether the hybrid mode is active or inactive. This binary representation of the operational status of the hybrid mode may enable the AMF to determine how CAG memberships are being handled by the femtocell 115. Additionally, or alternatively, the AMF may receive the list of member UEs 105 in the CAG from the UDM. The indication of the hybrid mode of operation and the list of member UEs 105 in the CAG may provide the AMF with a comprehensive view of the access network, and may facilitate sophisticated traffic management and policy execution. Additionally, or alternatively, the AMF may provide, to the femtocell 115, periodic requests for updates on a status of the hybrid mode of operation. This may enable the core network 120 (e.g., the AMF) to make proactive adjustments to manage network traffic more efficiently and dynamically distribute resources.

As further shown in FIG. 1B, and by reference number 145, the core network 120 may broadcast (e.g., via the base station 110) a membership status of the CAG ID to the UEs 105. For example, the core network 120 may utilize the base station 110 to provide an over-the-air broadcast of the membership status of the CAG ID to the UEs 105. The first UE 105-1 may receive a broadcast indicating that the first UE 105-1 is a member UE 105 of the CAG ID. The second UE 105-2 may receive the broadcast indicating that the second UE 105-2 is a non-member UE 105 of the CAG ID.

In some implementations, when broadcasting the membership status, the core network 120 may broadcast specific instructions or policies associated with the CAG ID to the UEs 105. These communications may delineate conditions and protocols for the UEs 105 accessing the femtocell 115 under different network states, and may guide the UEs 105 in navigating varying access availabilities and restrictions. Additionally, or alternatively, the core network 120 may implement encryption or other security measures when broadcasting the membership status of the CAG ID to the UEs 105, ensuring that only authorized UEs 105 can interpret and respond to the membership status information, thus preserving security integrity and protecting against unauthorized access. Additionally, or alternatively, instead of general broadcasts, the core network 120 may provide individualized messages to the first (member) UE 105-1 and the second (non-member) UE 105-2 to confirm CAG ID membership status and specific access privileges, which may ensure more tailored communication and clarity of access rights for each UE 105.

As shown in FIG. 1C, and by reference number 150, the femtocell 115 may broadcast the CAG ID and the indication of the hybrid mode of operation to the UEs 105. For example, the femtocell 115 may generate a message (e.g., a system information block (SIB) message) that includes the CAG ID, the indication of the hybrid mode of operation, a cell ID of the femtocell 115, a tracking area code associated with the femtocell 115, a public land mobile network (PLMN) ID associated with the femtocell 115, and/or the like. The femtocell 115 may broadcast the SIB message to the UEs 105, and the UEs 105 may receive the SIB message.

In some implementations, the SIB message may include a unique hybrid mode signal recognizable by all UEs 105 within range of the femtocell 115. The unique hybrid mode signal may include various forms, such as visual indicators, audible cues, or distinct network signals, allowing the UEs 105 to easily discern an availability and a state of the hybrid mode of operation of the femtocell 115. Additionally, or alternatively, upon broadcasting the CAG ID and the indication of the hybrid mode of operation to the UEs 105, the femtocell 115 may initiate an authentication process for the UEs 105 seeking access to the access network provided by the femtocell 115. This may streamline connection for member UEs 105 and may subject non-member UEs 105 to a conditional access protocol depending on network resource availability, thereby efficiently managing the capacity of the femtocell 115. Furthermore, the femtocell 115 may incorporate a feedback mechanism that enables the UEs 105 to respond to the hybrid mode broadcast (e.g., indicating priority status and intent to utilize the access network provided by the femtocell 115), which may enable the femtocell 115 to manage resources more effectively.

As further shown in FIG. 1C, and by reference number 155, the femtocell 115 may determine that there is no congestion associated with the access network provided by the femtocell 115. For example, the femtocell 115 may evaluate congestion associated with the access network provided by the femtocell 115 based on a threshold level of active connections with the femtocell 115. If a quantity of active connections with the femtocell 115 is below the threshold level of active connections, the femtocell 115 may determine that there is no congestion associated with an access network provided by the femtocell 115.

In some implementations, the femtocell 115 may utilize predictive analytics to determine whether there is congestion associated with the access network provided by the femtocell 115. The femtocell 115 may forecast potential network congestion situations based on historical data patterns and preemptively manage access of UEs 105 accordingly, ensuring a proactive approach to maintaining optimal access network performance. In some implementations, the femtocell 115 may determine whether there is congestion associated with the access network provided by the femtocell 115 based on determining whether resources of the femtocell 115 are sufficient to support additional UEs 105 without congestion, determining when a quantity of active connections with the access network approaches a maximum capacity of the femtocell 115, and/or the like. Additionally, or alternatively, the femtocell 115, when detecting an onset of congestion, may proactively notify member UEs 105. This notification may provide transparency and maintain user satisfaction by alerting member UEs 105 of an impending resource prioritization due to congestion.

As further shown in FIG. 1C, and by reference number 160, the femtocell 115 may provide access to member and non-member UEs 105 of the CAG when there is no congestion. For example, when there is no congestion detected at the access network provided by the femtocell 115, the femtocell 115 may provide member and non-member UEs 105 of the CAG with access to the access network. For example, as shown in FIG. 1C, the femtocell 115 may provide access to the first UE 105-1 and the second UE 105-2 when there is no congestion detected at the access network provided by the femtocell 115. In some implementations, when providing access to the member and non-member UEs 105, the femtocell 115 may implement a variable access tier system based on real-time network performance metrics. The tier system may adjust a quality of service (QoS) or a bandwidth allocation for member and non-member UEs 105 in accordance with the access network's current performance, ensuring optimal service quality for all UEs 105. Additionally, or alternatively, the femtocell 115 may utilize a reservation system where connectivity slots are reserved for member UEs 105. Such a reservation system may ensure that member UEs 105 always have priority access, even during high-demand periods, with the remaining slots being available to non-member UEs 105 on a first-come-first-serve basis.

As shown in FIG. 1D, and by reference number 165, the femtocell 115 may determine that there is congestion associated with the access network provided by the femtocell 115. For example, the femtocell 115 may evaluate congestion associated with the access network provided by the femtocell 115 based on a threshold level of active connections with the femtocell 115. If a quantity of active connections with the femtocell 115 is above the threshold level of active connections, the femtocell 115 may determine that there is congestion associated with an access network provided by the femtocell 115. The threshold level of active connections may depend on resources of the femtocell 115 (e.g., sixteen active connections for non-commercial use, sixty-four active connections for commercial use, and/or the like). In some implementations, the femtocell 115 may determine congestion based on real-time data traffic analysis. This real-time data traffic analysis may enable the femtocell 115 to dynamically adjust to varying levels of data traffic, thus providing a more responsive management of resources. Additionally, or alternatively, the femtocell 115 may implement alternative congestion management models, such as machine learning model-based predictions or historical usage patterns, to determine whether there is congestion associated with the access network provided by the femtocell 115. These alternative congestion management models may enhance the ability of the femtocell 115 to maintain optimal service levels by anticipating congestion before it occurs.

As further shown in FIG. 1D, and by reference number 170, the femtocell 115 may provide access to the member UEs 105 and preempt non-member UEs 105 of the CAG when there is congestion. For example, the femtocell 115, upon determining congestion, may prioritize member UEs 105 over non-member UEs 105 based on predefined network policies and a priority level associated with different types of services utilized by the member UEs 105. For example, as shown FIG. 1D, the femtocell 115 provide access to the first UE 105-1 and preempt the second UE 105-2 from accessing the access network provided by the femtocell 115 when there is congestion detected at the access network provided by the femtocell 115. Additionally, or alternatively, in scenarios where congestion is determined, the femtocell 115 may selectively throttle bandwidth of non-member UEs 105 rather than denying access outright. This strategy may maintain a service balance by prioritizing member UEs 105 while still providing some service continuity to non-member UEs 105. In some implementations, the femtocell 115 may prioritize member UEs 105 by evaluating service priority levels, potentially bumping member UEs 105 with lower priority if all connected UEs 105 are members and resources are still constrained. Additionally, or alternatively, the femtocell 115 may evaluate the priorities of active connections and may preempt non-member UEs 105 based on types of services utilizes by the non-member UEs 105, such as non-essential data services like streaming, in favor of voice or emergency services for member UEs 105. This selective prioritization may ensure that critical communication services are maintained during peak congestion.

The femtocell 115 may direct non-member UEs 105 to connect to an alternative access network (e.g., the base station 110) when member UEs 105 require service, and the femtocell 115 is near capacity. Upon reaching capacity, the femtocell 115 may offer different levels of service to non-member UEs 105 instead of completely disconnecting the non-member UEs 105, such as reduced data speeds or limited access to certain services, thereby balancing resource usage without fully denying service.

FIG. 1E is an example call flow diagram associated with providing a femtocell hybrid access mode to UEs 105. As shown at step 1 of FIG. 1E, the user device 125 may be utilized to configure the hybrid mode of operation and the list of member UEs 105 in the CAG. For example, the user may cause the user device 125 to configure the hybrid mode of operation for the femtocell 115, and to generate the list of member UEs 105 in the CAG. In some implementations, a network management system may be utilized to configure the hybrid mode of operation and the list of member UEs 105 in the CAG. The network management system may provide comprehensive control and oversight for an operator to manage the femtocell 115 and associated UEs 105 from a centralized system, offering a more robust and scalable solution compared to configurations via the user device 125. Additionally, or alternatively, the hybrid mode of operation and the list of member UEs 105 in the CAG may be configured through a direct interface with a centralized subscriber database (e.g., the UDM of the core network 120). By interfacing with such a database, operators can efficiently manage the list of member UEs 105 and the CAG ID configuration, ensuring seamless communication with the femtocell 115 and network devices of the core network 120 for improved operational efficiency.

As shown at step 2 of FIG. 1E, the user device 125 may generate the CAG ID. For example, the user may cause the user device 125 to generate the CAG ID. Additionally, or alternatively, the generation of the CAG ID may be performed automatically by the femtocell 115 upon receipt of configuration data from the user device 125 or the network management system. This may streamline the process since the femtocell 115 may dynamically generate and update the CAG ID without requiring a separate configuration step by the user device 125, enhancing the ease of setup and responsiveness of the femtocell 115.

As shown at step 3 of FIG. 1E, the user device 125 may provide an indication of the hybrid mode of operation and the CAG ID to the femtocell 115. For example, the user may cause the user device 125 to provide the indication of the hybrid mode of operation and the CAG ID to the femtocell 115, and the femtocell 115 may receive the indication of the hybrid mode of operation and the CAG ID. Alternatively, the indication of the hybrid mode of operation and the CAG ID may be pushed to the femtocell 115 by the network management system, rather than being provided by user device 125. This may ensure that the femtocell 115 operates in harmony with broader network policy (e.g., of the core network 120) and allows for timely adjustments to configuration to keep up with changing service demands.

As shown at step 4 of FIG. 1E, the user device 125 may provide the CAG ID and the list of member UEs 105 to the UDM of the core network 120. For example, the user may cause the user device 125 to provide the CAG ID and the list of member UEs 105 to the UDM of the core network 120, and the UDM may receive and store the CAG ID and the list of member UEs 105. Alternatively, the CAG ID and the list of member UEs 105 may be provided to the UDM by directly interfacing with a centralized subscriber database. This may provide more reliable and direct synchronization of member UE 105 details, leading to more accurate and efficient management of access privileges within the access network provided by the femtocell 115.

As shown at step 5 of FIG. 1E, the femtocell 115 may provide a cell ID of the femtocell 115, the indication of the hybrid mode of operation, and the CAG ID to the AMF of the core network 120. For example, the femtocell 115 may generate a message that includes the cell ID of the femtocell 115, the indication of the hybrid mode of operation, and the CAG ID. The femtocell 115 may provide the message to the AMF, and the AMF may receive and store the cell ID of the femtocell 115, the indication of the hybrid mode of operation, and the CAG ID. Additionally, or alternatively, a provisioning server may communicate the cell ID of the femtocell 115, the indication of the hybrid mode of operation, and the CAG ID to the AMF, rather than the femtocell 115 providing this information directly. The provisioning server may serve to offload this task from the femtocell 115, possibly allowing the femtocell 115 to manage resources better and improve overall network efficiency.

As shown at step 6 of FIG. 1E, the UEs 105 may be updated with the CAG membership indicating whether a UE 105 is a member UE 105 or a non-member UE 105 (e.g., within the coverage area of the femtocell 115). For example, UEs 105 may be updated over-the-air to reflect CAG membership status. For example, the first UE 105-1 may be updated to indicate that the first UE 105-1 is a member UE 105 of the CAG ID, and the second UE 105-2 may be updated to indicate that the second UE 105-2 is a non-member UE 105 of the CAG ID. Alternatively, the UEs 105 may be configured with CAG membership status during initial activation or provisioning. This may provide a more secure and controlled environment for assigning access privileges, as opposed to over-the-air updates which might be more susceptible to interference or unauthorized access.

As shown at step 7 of FIG. 1E, the femtocell 115 may broadcast the CAG ID and the indication of the hybrid mode of operation to the UEs 105. For example, the femtocell 115 may generate a message (e.g., a SIB message) that includes the CAG ID, the indication of the hybrid mode of operation, a cell ID of the femtocell 115, a tracking area code associated with the femtocell 115, a PLMN ID associated with the femtocell 115, and/or the like. The femtocell 115 may broadcast the SIB message to the UEs 105, and the UEs 105 may receive the SIB message. Alternatively, the femtocell 115 may send targeted messages to UEs 105 in proximity of the femtocell 115, based on prior connectivity data. This targeted communication approach may promote more efficient use of the resources of the femtocell and may prevent unnecessary signaling in the access network.

As shown at step 8 of FIG. 1E, the femtocell 115 may allow member and non-member UEs 105 access to the access network provided by the femtocell 115. For example, when there is no congestion detected at the access network provided by the femtocell 115, the femtocell 115 may provide member and non-member UEs 105 of the CAG with access to the access network. Alternatively, the femtocell 115 may provide access to the member and non-member UEs 105 based on predetermined time slots or access levels. This would enable a more structured and equitable distribution of resources by the femtocell 115, particularly in scenarios of variable network demand or when aiming to comply with specific service agreements.

As shown at step 9 of FIG. 1E, the femtocell 115 may detect congestion in the access network provided by the femtocell 115. For example, the femtocell 115 may evaluate congestion associated with the access network provided by the femtocell 115 based on a threshold level of active connections with the femtocell 115. If a quantity of active connections with the femtocell 115 is above the threshold level of active connections, the femtocell 115 may determine that there is congestion associated with an access network provided by the femtocell 115. The femtocell 115 may additionally factor in QoS parameters along with the quantity of active connections when detecting congestion in the access network. This approach to congestion detection may enable the femtocell 115 to make more informed decisions on resource allocation and service provision, prioritizing critical services or maintaining certain QoS levels even under congested conditions.

As shown at step 10 of FIG. 1E, the femtocell 115 may preempt non-member UEs 105 due to the congestion. For example, when the femtocell 115 determines that there is congestion associated with an access network provided by the femtocell 115, the femtocell 115 may preempt non-member UEs 105 from accessing the access network due to the congestion. Alternatively, the femtocell 115 may throttle data rates for non-member UEs 105 to prioritize member UEs 105 without entirely disconnecting the non-member UEs 105. This may allow non-member UEs 105 to maintain some level of access while still providing preferential treatment to member UEs 105, ensuring a balance between access fairness and adherence to the hybrid mode's priority rules.

FIG. 1F is an example flowchart associated with providing a femtocell hybrid access mode to UEs 105. As shown at step 1 of FIG. 1F, the femtocell 115 may be in the hybrid mode of operation and may be experiencing congestion. For example, the femtocell 115 may assess congestion levels by considering a threshold of active connections, data throughput levels, signal quality, patterns of demand, and/or the like. In some implementations, the femtocell 115 may determine that the femtocell 115 is experiencing congestion based on determining that a quantity of active connections approaches a maximum capacity of the femtocell 115. Additionally, or alternatively, the femtocell 115 may determine that the femtocell 115 is experiencing congestion based on assessing real-time data throughput against anticipated throughput levels for member and non-member UEs 105.

As shown at step 2 of FIG. 1F, a member UE 105 may attempt to connect to the femtocell 115. For example, a member UE 105 may attempt to connect to the femtocell 115 while the femtocell is experiencing congestion. The femtocell 115 may provide priority access to the member UE 105 based on the list of member UEs 105 associated with the CAG, and based on factors, such as subscription type, service plan, historical bandwidth consumption, and/or the like associated with the member UE 105. Additionally, or alternatively, the femtocell 115 may prioritize the member UE 105 based on a longevity and a value of a service plan for the member UE 105, thus rewarding loyalty and higher service tiers.

As shown at step 3 of FIG. 1F, the femtocell 115 may determine whether a non-member UE 105 has an active connection with the femtocell 115. For example, the femtocell 115 may determine whether the non-member UE 105 has an active connection based on an MDNs or another identifier associated with the non-member UE 105. The femtocell 115 may determine whether the identifier associated with the non-member UE 105 is communicating with the femtocell 115. If the identifier associated with the non-member UE 105 is communicating with the femtocell 115, the femtocell 115 may determine that the non-member UE 105 has an active connection with the femtocell 115. Otherwise, the femtocell 115 may determine that the non-member UE 105 does not have an active connection with the femtocell 115.

If a non-member UE 105 does not have an active connection with the femtocell 115 (step 3—No), the femtocell 115 may redirect the member UE 105 to a nearby cell (e.g., the base station 110), as shown at step 4 of FIG. 1F. For example, if no non-member UE 105 with an active connection is identified, the femtocell 115 may direct the member UE 105 to another cell (e.g., to the base station 110). In managing this redirection, the femtocell 115 may determine the optimal cell based on real-time congestion analysis of neighboring cells, ensuring that the member UE 105 experiences minimal disruptions to service. In some implementations, prior to redirection, the femtocell 115 may evaluate different cells based on existing service priorities and live congestion data to identify an optimum alternative cell for the member UE 105. Additionally, or alternatively, rather than redirecting based on proximity alone, the femtocell 115 may redirect the member UE 105 to a cell where the member UE 105 will experience higher-quality service, thereby enhancing an overall experience for the member UE 105.

If a non-member UE 105 has an active connection with the femtocell 115 (step 3—Yes), the femtocell 115 may determine whether there is more than one non-member UE 105 with active connections with the femtocell 115, as shown at step 5 of FIG. 1F. For example, if the non-member UE 105 has active connection with the femtocell 115, the femtocell 115 may determine whether more than one non-member UE 105 has active connections based on factors, such as connection duration, data consumption, service type, and/or the like. In some implementations, the femtocell 115 may determine a duration of the active connection of each non-member UE 105, wherein longer duration connections may be preserved over newer connections. Additionally, or alternatively, active connections of the non-member UEs 105 utilizing more intensive data services may be deprioritized to maintain network integrity for other less demanding services.

If the femtocell 115 determines that there is more than one non-member UE 105 with active connections with the femtocell 115 (step 5—Yes), the femtocell 115 may select a connection with a lowest priority for a non-member UE 105, as shown at step 6 of FIG. 1F, and may redirect a non-member UE 105 to the nearby cell (e.g., the base station 110), as shown at step 7 of FIG. 1F. For example, if the femtocell 115 determines that there is more than one non-member UE 105 with active connections, the femtocell 115 may select which connection to disconnect based on metrics, such as a randomized selection process, prioritization based on the time of connection initiation, and/or the like. In some implementations, the selection may involve utilizing a lottery approach to ensure fairness among non-member UEs 105, thereby minimizing the potential for perceived bias in the decision-making process. When deciding priorities and connection maintenance for the non-member UEs 105, the femtocell 115 may consider the importance of ongoing sessions, projected network traffic, and/or the like. In some implementations, the femtocell 115 may evaluate ongoing sessions for criticality, ensuring that essential communications are preserved. Regarding redirecting the non-member UE 105 to a nearby cell, the femtocell 115 may provide alternative recommendations or offer temporary enhanced service options to maintain service quality during the transition. In some implementations, the femtocell 115 may direct non-member UEs 105 to cells offering superior signal quality or incentivize the non-member UEs 105 with temporary service enhancements to counterbalance any inconvenience caused by the redirection.

If the femtocell 115 determines that there is not more than one non-member UE 105 with active connections with the femtocell 115 (step 5—No), the femtocell 115 may redirect a non-member UE 105 to the nearby cell (e.g., the base station 110), as shown at step 7 of FIG. 1F. For example, if the femtocell 115 determines that there is not more than one non-member UE 105 with active connections, the femtocell 115 may redirect the non-member UE 105 to a nearby cell by providing alternative recommendations or offering temporary enhanced service options to maintain service quality during the transition. In some implementations, the femtocell 115 may direct non-member UEs 105 to cells offering superior signal quality or incentivize the non-member UEs 105 with temporary service enhancements to counterbalance any inconvenience caused by the redirection.

In this way, the femtocell 115 provides a femtocell hybrid access mode to UEs 105. For example, the femtocell 115 may enable dynamic expansion and contraction of femtocell resource availability in response to real-time access network conditions and UE access classification. The femtocell 115 may optimize traffic handling by dynamically shifting between the open access mode and the closed access mode. Additionally, the femtocell 115 provides seamless integration with broader network infrastructure, achieving enhanced network management efficiency and technical coherence across an entire network system. Thus, the femtocell 115 may conserve computing resources, networking resources, and/or other resources that would have otherwise been consumed by providing access to all UEs 105 even when femtocell resources are limited, failing to provide access to non-approved UEs 105 when femtocell resources are available, failing to determine when the femtocell 115 is able to provide additional UEs 105 (e.g., whether approved or non-approved) with access to the femtocell 115.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

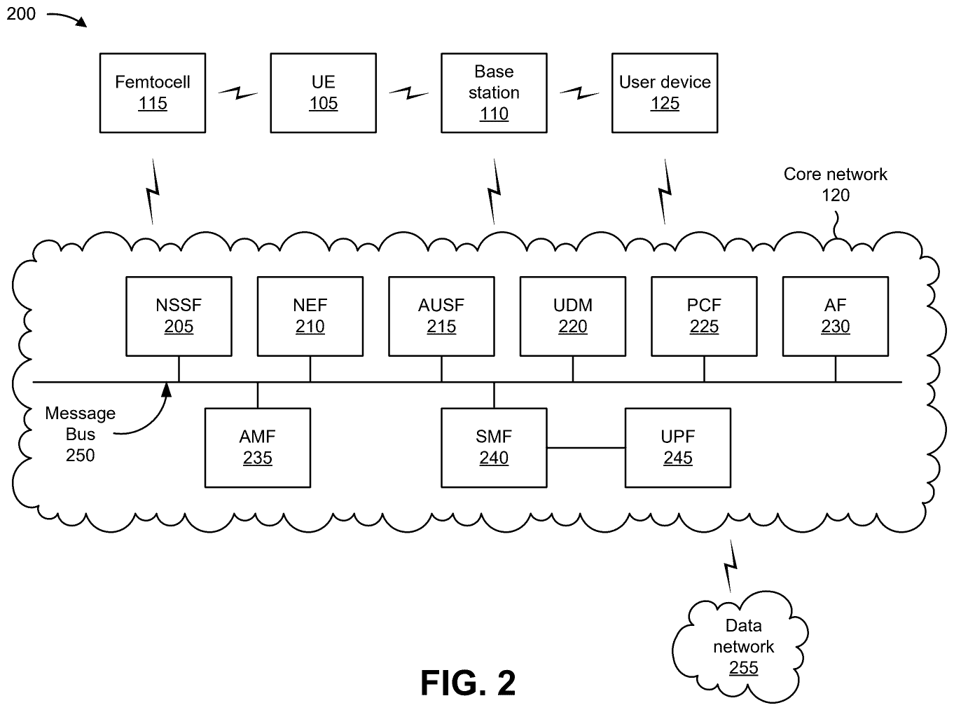

FIG. 2 is a diagram of an example environment 200 in which systems and/or methods described herein may be implemented. As shown in FIG. 2, the example environment 200 may include the UE 105, the base station 110, the femtocell 115, the core network 120, the user device 125, and a data network 255. Devices and/or networks of the example environment 200 may interconnect via wired connections, wireless connections, or a combination of wired and wireless connections.

The UE 105 includes one or more devices capable of receiving, generating, storing, processing, and/or providing information, such as information described herein. For example, the UE 105 may include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The base station 110 may support, for example, a cellular radio access technology (RAT). The base station 110 may include one or more base stations (e.g., base transceiver stations, radio base stations, node Bs, eNodeBs (eNBs) (e.g., the 4G base station 110), gNodeBs (gNBs) (e.g., the 5G base stations 110-1 and 110-2), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The base station 110 may transfer traffic between the UE 105 (e.g., using a cellular RAT), one or more base stations (e.g., using a wireless interface or a backhaul interface, such as a wired backhaul interface), and/or the core network 120. The base station 110 may provide one or more cells that cover geographic areas.

In some implementations, the base station 110 may perform scheduling and/or resource management for the UE 105 covered by the base station 110 (e.g., the UE 105 covered by a cell provided by the base station 110). In some implementations, the base station 110 may be controlled or coordinated by a network controller, which may perform load balancing, network-level configuration, and/or other operations. The network controller may communicate with the base station 110 via a wireless or wireline backhaul. In some implementations, the base station 110 may include a network controller, a self-organizing network (SON) module or component, or a similar module or component. In other words, the base station 110 may perform network control, scheduling, and/or network management functions (e.g., for uplink, downlink, and/or sidelink communications of the UE 105 covered by the base station 110).

The femtocell 115 includes one or more devices capable of receiving, generating, storing, processing, and/or providing information, as described elsewhere herein. For example, the femtocell 115 may include femtocell base station, a network extender, a home gNodeB, a portable plug and play mini base station, and/or the like. In some implementations, the femtocell 115 may include a small, low-power cellular base station designed to enhance network coverage and improve signal quality in areas with weak cellular signals (e.g., such as at home locations, small business locations, and/or the like).

The user device 125 may include one or more devices capable of receiving, generating, storing, processing, and/or providing information, as described elsewhere herein. The user device 125 may include a communication device and/or a computing device. For example, the user device 125 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

In some implementations, the core network 120 may include an example functional architecture in which systems and/or methods described herein may be implemented. For example, the core network 120 may include an example architecture of a 5G next generation (NG) core network included in a 5G wireless telecommunications system. While the example architecture of the core network 120 shown in FIG. 2 may be an example of a service-based architecture, in some implementations, the core network 120 may be implemented as a reference-point architecture and/or a 4G core network, among other examples.

As shown in FIG. 2, the core network 120 may include a number of functional elements. The functional elements may include, for example, a network slice selection function (NSSF) 205, a network exposure function (NEF) 210, an authentication server function (AUSF) 215, a UDM component 220, a policy control function (PCF) 225, an application function (AF) 230, an AMF 235, a session management function (SMF) 240, and/or a user plane function (UPF) 245. These functional elements may be communicatively connected via a message bus 250. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 205 includes one or more devices that select network slice instances for the UE 105. By providing network slicing, the NSSF 205 allows an operator to deploy multiple substantially independent end-to-end networks potentially with the same infrastructure. In some implementations, each slice may be customized for different services.

The NEF 210 includes one or more devices that support exposure of capabilities and/or events in the wireless telecommunications system to help other entities in the wireless telecommunications system discover network services.

The AUSF 215 includes one or more devices that act as an authentication server and support the process of authenticating the UE 105 in the wireless telecommunications system.

The UDM 220 includes one or more devices that store user data and profiles in the wireless telecommunications system. The UDM 220 may be used for fixed access and/or mobile access in the core network 120.

The PCF 225 includes one or more devices that provide a policy framework that incorporates network slicing, roaming, packet processing, and/or mobility management, among other examples.

The AF 230 includes one or more devices that support application influence on traffic routing, access to the NEF 210, and/or policy control, among other examples.

The AMF 235 includes one or more devices that act as a termination point for non-access stratum (NAS) signaling and/or mobility management, among other examples.

The SMF 240 includes one or more devices that support the establishment, modification, and release of communication sessions in the wireless telecommunications system. For example, the SMF 240 may configure traffic steering policies at the UPF 245 and/or may enforce user equipment Internet protocol (IP) address allocation and policies, among other examples.

The UPF 245 includes one or more devices that serve as an anchor point for intraRAT and/or interRAT mobility. The UPF 245 may apply rules to packets, such as rules pertaining to packet routing, traffic reporting, and/or handling user plane QoS, among other examples.

The message bus 250 represents a communication structure for communication among the functional elements. In other words, the message bus 250 may permit communication between two or more functional elements.

The data network 255 includes one or more wired and/or wireless data networks. For example, the data network 255 may include an IP Multimedia Subsystem (IMS), a PLMN, a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example environment 200 may perform one or more functions described as being performed by another set of devices of the example environment 200.

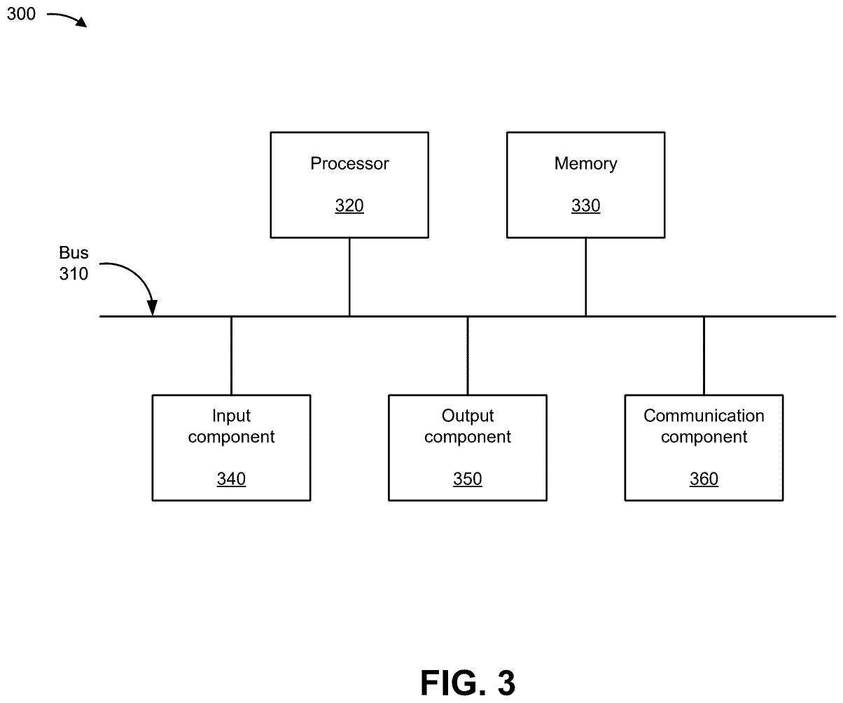

FIG. 3 is a diagram of example components of a device 300, which may correspond to the UE 105, the base station 110, the femtocell 115, the user device 125, the NSSF 205, the NEF 210, the AUSF 215, the UDM 220, the PCF 225, the AF 230, the AMF 235, the SMF 240, and/or the UPF 245. In some implementations, the UE 105, the base station 110, the femtocell 115, the user device 125, the NSSF 205, the NEF 210, the AUSF 215, the UDM 220, the PCF 225, the AF 230, the AMF 235, the SMF 240, and/or the UPF 245 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

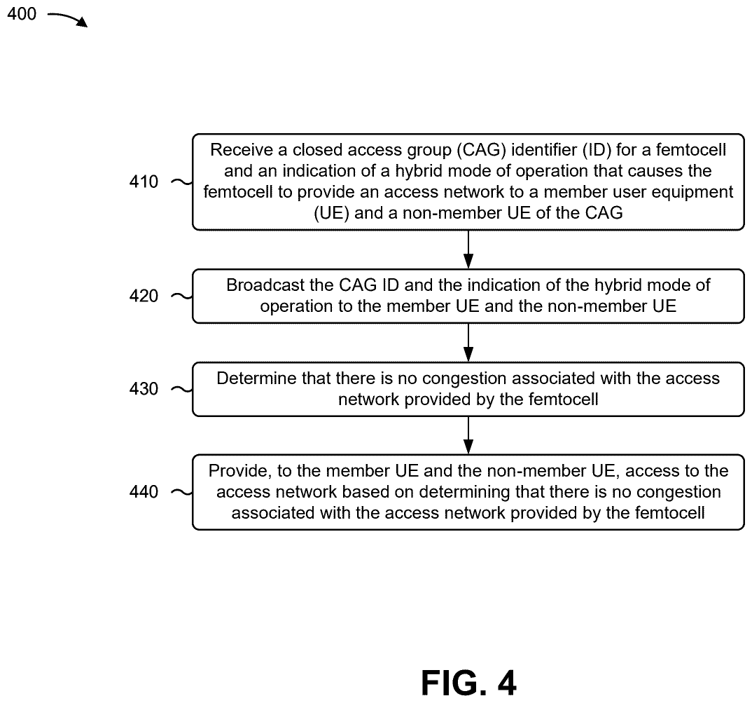

FIG. 4 is a flowchart of an example process 400 for providing a femtocell hybrid access mode to UEs. In some implementations, one or more process blocks of FIG. 4 may be performed by a device (e.g., the femtocell 115). In some implementations, one or more process blocks of FIG. 4 may be performed by another device or a group of devices separate from or including the device, such as a network device of the core network 120. Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving a CAG ID for the femtocell and an indication of a hybrid mode of operation that causes the femtocell to provide an access network to a member UE and a non-member UE of the CAG (block 410). For example, the femtocell may receive a CAG ID for the femtocell and an indication of a hybrid mode of operation that causes the femtocell to provide an access network to a member UE and a non-member UE of the CAG, as described above. In some implementations, the member UE is included in a list of member UEs associated with the CAG. In some implementations, the member UE and the non-member UE are updated over-the-air with a CAG membership status. In some implementations, the hybrid mode of operation is configurable via a portal by an operator or an owner of the femtocell. In some implementations, the femtocell prioritizes the member UE based on predefined network policies and a priority level associated with different types of services being utilized by the member UE. In some implementations, the hybrid mode of operation is indicated by a binary value representative of an active operational status or an inactive operational status.

As further shown in FIG. 4, process 400 may include broadcasting the CAG ID and the indication of the hybrid mode of operation to the member UE and the non-member UE (block 420). For example, the femtocell may broadcast the CAG ID and the indication of the hybrid mode of operation to the member UE and the non-member UE, as described above. In some implementations, broadcasting the indication of the hybrid mode of operation includes indicating, within a message, an operational status of the hybrid mode of operation as either active or inactive.

As further shown in FIG. 4, process 400 may include determining that there is no congestion associated with the access network provided by the femtocell (block 430). For example, the femtocell may determine that there is no congestion associated with the access network provided by the femtocell, as described above.

As further shown in FIG. 4, process 400 may include providing, to the member UE and the non-member UE, access to the access network based on determining that there is no congestion associated with the access network provided by the femtocell (block 440). For example, the femtocell may provide, to the member UE and the non-member UE, access to the access network based on determining that there is no congestion associated with the access network provided by the femtocell, as described above. In some implementations, providing, to the member UE and the non-member UE, access to the access network based on determining that there is no congestion associated with the access network includes determining that resources of the femtocell are sufficient to support additional UEs without congestion, and allowing the member UE and the non-member UE to access the access network based on determining that the resources of the femtocell are sufficient to support additional UEs without congestion.

In some implementations, process 400 includes determining, at a later time, that there is congestion associated with the access network provided by the femtocell, and providing, to only the member UE, access to the access network based on determining that there is congestion associated with the access network provided by the femtocell. In some implementations, process 400 includes providing the CAG ID and the indication of the hybrid mode of operation to a network device of a core network associated with the femtocell. In some implementations, process 400 includes evaluating congestion associated with the access network based on a threshold level of active connections with the femtocell.

In some implementations, process 400 includes causing the non-member UE to connect to an alternative access network when the member UE requires service and the femtocell is near capacity. In some implementations, process 400 includes determining when a quantity of active connections with the access network approaches a maximum capacity of the femtocell, and evaluating priorities of the member UE and other member UEs based on determining when the quantity of active connections with the access network approaches the maximum capacity of the femtocell.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a femtocell, a closed access group (CAG) identifier (ID) for the femtocell and an indication of a hybrid mode of operation that causes the femtocell to provide an access network to a member user equipment (UE) and a non-member UE of the CAG;
broadcasting, by the femtocell, the CAG ID and the indication of the hybrid mode of operation to the member UE and the non-member UE;
determining, by the femtocell, that there is no congestion associated with the access network provided by the femtocell; and
providing, by the femtocell and to the member UE and the non-member UE, access to the access network based on determining that there is no congestion associated with the access network provided by the femtocell.

2. The method of claim 1, further comprising:
determining, at a later time, that there is congestion associated with the access network provided by the femtocell; and
providing, to only the member UE, access to the access network based on determining that there is congestion associated with the access network provided by the femtocell.

3. The method of claim 1, wherein the member UE is included in a list of member UEs associated with the CAG.

4. The method of claim 1, further comprising:
providing the CAG ID and the indication of the hybrid mode of operation to a network device of a core network associated with the femtocell.

5. The method of claim 1, further comprising:
evaluating congestion associated with the access network based on a threshold level of active connections with the femtocell.

6. The method of claim 1, wherein the member UE and the non-member UE are updated over-the-air with a CAG membership status.

7. The method of claim 1, wherein broadcasting the indication of the hybrid mode of operation comprises:
indicating, within a message, an operational status of the hybrid mode of operation as either active or inactive.

8. A femtocell, comprising:
one or more processors configured to:
receive a closed access group (CAG) identifier (ID) for the femtocell and an indication of a hybrid mode of operation that causes the femtocell to provide an access network to a member user equipment (UE) and a non-member UE of the CAG;
broadcast the CAG ID and the indication of the hybrid mode of operation to the member UE and the non-member UE;
evaluate congestion associated with the access network based on a threshold level of active connections with the femtocell;
determine that there is no congestion associated with the access network based on evaluating the congestion associated with the access network; and
provide, to the member UE and the non-member UE, access to the access network based on determining that there is no congestion associated with the access network provided by the femtocell.

9. The femtocell of claim 8, wherein the one or more processors, to provide, to the member UE and the non-member UE, access to the access network based on determining that there is no congestion associated with the access network, are configured to:
determine that resources of the femtocell are sufficient to support additional UEs without congestion; and
allow the member UE and the non-member UE to access the access network based on determining that the resources of the femtocell are sufficient to support additional UEs without congestion.

10. The femtocell of claim 8, wherein the hybrid mode of operation is configurable via a portal by an operator or an owner of the femtocell.

11. The femtocell of claim 8, wherein the one or more processors are further configured to:
cause the non-member UE to connect to an alternative access network when the member UE requires service and the femtocell is near capacity.

12. The femtocell of claim 8, wherein the femtocell prioritizes the member UE based on predefined network policies and a priority level associated with different types of services being utilized by the member UE.

13. The femtocell of claim 8, wherein the one or more processors are further configured to:
determine when a quantity of active connections with the access network approaches a maximum capacity of the femtocell; and
evaluate priorities of the member UE and other member UEs based on determining when the quantity of active connections with the access network approaches the maximum capacity of the femtocell.

14. The femtocell of claim 8, wherein the hybrid mode of operation is indicated by a binary value representative of an active operational status or an inactive operational status.

15. A non-transitory computer-readable medium storing a set of instructions, the set of instructions comprising:
one or more instructions that, when executed by one or more processors of a femtocell, cause the femtocell to:
receive a closed access group (CAG) identifier (ID) for the femtocell and an indication of a hybrid mode of operation that causes the femtocell to provide an access network to a member user equipment (UE) and a non-member UE of the CAG,
wherein the hybrid mode of operation is indicated as an active operational status or an inactive operational status;
broadcast the CAG ID and the indication of the hybrid mode of operation to the member UE and the non-member UE;
determine that there is no congestion associated with the access network provided by the femtocell; and
provide, to the member UE and the non-member UE, access to the access network based on determining that there is no congestion associated with the access network provided by the femtocell.

16. The non-transitory computer-readable medium of claim 15, wherein the one or more instructions further cause the femtocell to:
determine, at a later time, that there is congestion associated with the access network provided by the femtocell; and
provide, to only the member UE, access to the access network based on determining that there is congestion associated with the access network provided by the femtocell.

17. The non-transitory computer-readable medium of claim 15, wherein the one or more instructions further cause the femtocell to:
evaluate congestion associated with the access network based on a threshold level of active connections with the femtocell.

18. The non-transitory computer-readable medium of claim 15, wherein the one or more instructions, that cause the femtocell to provide, to the member UE and the non-member UE, access to the access network based on determining that there is no congestion associated with the access network, cause the femtocell to:
determine that resources of the femtocell are sufficient to support additional UEs without congestion; and
allow the member UE and the non-member UE to access the access network based on determining that the resources of the femtocell are sufficient to support additional UEs without congestion.

19. The non-transitory computer-readable medium of claim 15, wherein the one or more instructions further cause the femtocell to:
cause the non-member UE to connect to an alternative access network when the member UE requires service and the femtocell is near capacity.

20. The non-transitory computer-readable medium of claim 15, wherein the one or more instructions further cause the femtocell to:
determine when a quantity of active connections with the access network approaches a maximum capacity of the femtocell; and
evaluate priorities of the member UE and other member UEs based on determining when the quantity of active connections with the access network approaches the maximum capacity of the femtocell.
